(19) United States
(12) Patent Application Publication
(10) Pub. No.: US 2023/0242031 A1
(43) Pub. Date: Aug. 3, 2023

(54) MOBILE CHILD-RELATED FACILITY

(71) Applicant: The CornHer Office, LLC, Bryan, TX (US)

(72) Inventors: Cheryl JACKSON, Bryan, TX (US); Erika HULL, Bryan, TX (US)

(21) Appl. No.: 17/589,218

(22) Filed: Jan. 31, 2022

(51) Int. Cl. B60P 3/38; B60R 15/04; B60N 3/10; B60R 15/02; B60P 3/025; B60N 3/00; B60P 3/34; B60R 25/24

(52) U.S. Cl. CPC B60P 3/38; B60N 3/001; B60N 3/10; B60P 3/0257; B60P 3/343; B60R 15/02; B60R 15/04; B60R 25/24; B60R 25/01

(57) ABSTRACT

A mobile child-related facility includes a compartment having one or more access means to provide admission into the compartment. The compartment includes at least one child-friendly relieving area; at least one child-friendly utility space; and at least one vending station including a product vending machine for dispensing one or more products for consumption during child-related activities. The child-friendly relieving area, the child-friendly utility space, and the vending station are independent of each other and are accessible through the one or more access means.

### BACKGROUND OF THE INVENTION

Young children, such as toddlers and infants, and individuals with mental or physical disabilities, require extra care especially when taken to public places such as shopping malls, parks, theatres, outdoor events, and the like. Particularly challenging is the safe and clean caretaking of such young children, for example, when they need extra care during relieving, nursing, napping, and similar caretaking activities.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is an exemplary front view of a mobile child-related facility having a compartment with child-related facilities, in accordance with some embodiments;

FIG. 2 is an exemplary interior layout of the compartment having one or more walls to partition off one or more regions of the compartment, in accordance with some embodiments;

FIG. 3 is an exemplary interior layout of the compartment with the walls of FIG. 2 removed, in accordance with some embodiments;

FIGS. 4A through 4C are various views of the compartment having an exemplary interior layout in variation with the interior layouts illustrated in FIGS. 2 and 3, in accordance with some embodiments; and

FIG. 5 is an exemplary interior layout in variation with the interior layouts illustrated in FIGS. 2, 3, and FIGS. 4A through 4C, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

The apparatus and method components have been represented where appropriate by conventional symbols in the drawings, showing only those specific details that are pertinent to understanding the embodiments so as not to obscure the description with details that will be readily apparent to those of ordinary skill in the art having the benefit of the description herein.

### DETAILED DESCRIPTION OF THE INVENTION

The embodiments described herein are related to a mobile child-related facility, and, in particular, to a mobile child-related facility having regions that have amenities usable for caretaking a young child.

In one aspect, a mobile child-related facility is described. The mobile child-related facility includes a compartment having one or more access means to provide admission into the compartment. The compartment includes at least one child-friendly relieving area; at least one child-friendly utility space; and at least one vending station including a product vending machine for dispensing one or more products for consumption during child-related activities. The child-friendly relieving area, the child-friendly utility space, and the vending station are independent of each other and are accessible through the one or more access means.

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

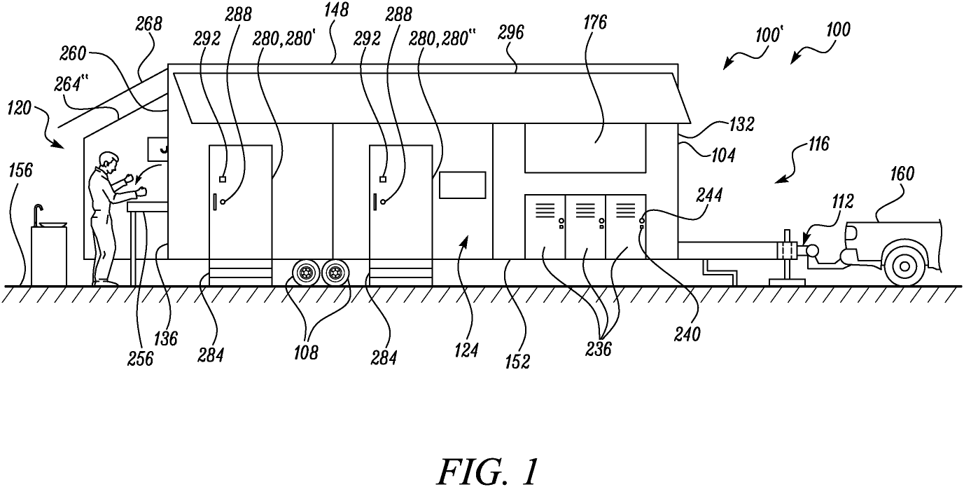

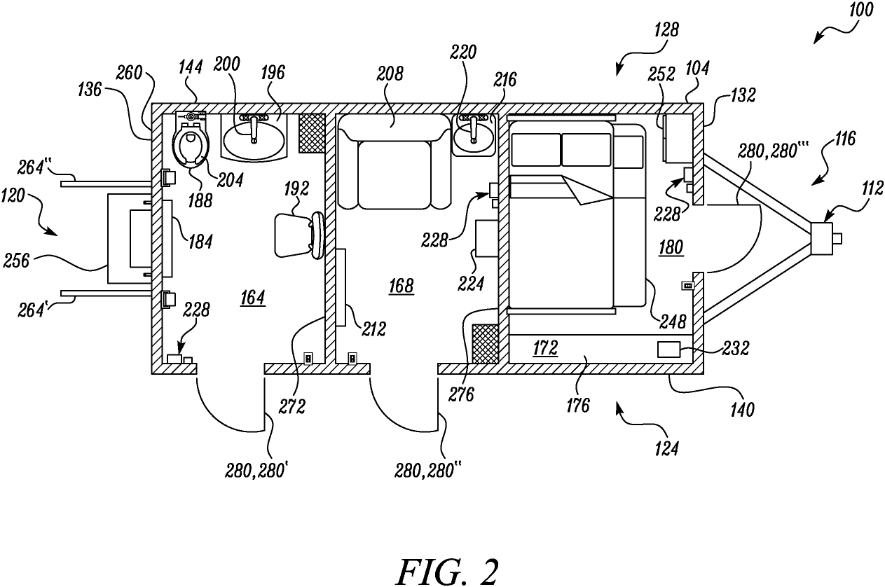

Referring to FIGS. 1 and 2, a mobile child-related facility 100 is illustrated and described. It will be appreciated that although throughout the description caretaking facilities for a child are described, in an alternate embodiment, the same facility can be implemented for caretaking of an adult, such as an individual with mental or physical disabilities. The mobile child-related facility 100 includes a compartment 104. The compartment 104 defines a forward end 116, a rearward end 120 opposite to the forward end 116, and a first lateral side 124 and a second lateral side 128 spanning between the forward end 116 and the rearward end 120. In some embodiments, the compartment 104 includes one or more outer walls, namely and exemplarily, a forward wall 132, a rearward wall 136, a first lateral sidewall 140, and a second lateral sidewall 144. The forward wall 132 can be located at the forward end 116, the rearward wall 136 can be located at the rearward end 120, the first lateral sidewall 140 can be located at the first lateral side 124, and the second lateral sidewall 144 can be located at the second lateral side 128. In some embodiments, the forward wall 132, the rearward wall 136, the first lateral sidewall 140, and the second lateral sidewall 144, can together impart a rectangular configuration to the compartment 104.

The compartment 104 also includes a roof structure 148 and a floor structure 152, with each of the forward wall 132, the rearward wall 136, the first lateral sidewall 140, and the second lateral sidewall 144, extending between the roof structure 148 and the floor structure 152, thereby delimiting a boundary of the compartment 104 and defining an interior space of the compartment 104. Although not limited, the configuration of the compartment 104, as described above, imparts a generally boxed or a cuboidal structure to the compartment 104. It may be noted, however, that the configuration of the compartment 104, as described above, is purely exemplary and provided for illustrative purposes and the compartment 104 can include any other configuration.

In some embodiments, the mobile child-related facility 100 can include or be built into a mobile trailer 100′ and can include a set of traction devices 108 to facilitate a movement of the mobile child-related facility 100 from one location to another location. In this regard, the traction devices 108 can include wheels, or similar devices, that support the compartment 104 on a surface 156 (for example, a ground surface) so as to facilitate a movement of the mobile child-related facility 100 with respect to the surface 156. To attain such movement, the mobile child-related facility 100 can include a hitching mechanism 112. The hitching mechanism 112 can be used to couple the mobile child-related facility 100 with a vehicle 160 (for example, a pickup truck), such that as the vehicle 160 moves, the mobile child-related facility 100 can trail behind and move along with the vehicle 160, and be moved between various locations.

In some embodiments, the mobile child-related facility 100 can be built into or integrated into any automotive vehicle, such as a bus, a van, or any other vehicle, such as parade floats, such that the mobile child-related facility 100 need not trail behind a vehicle, but rather can be hauled directly on road by being a part of a vehicle. When the mobile child-related facility 100 is wholly formed within an existing vehicle, such as a bus, a van, or other such vehicles, the hitching mechanism 112 and/or the traction devices 108 can be omitted or remain unused.

As an example, the hitching mechanism 112 is arranged at the forward end 116 of the compartment 104. In some embodiments, the hitching mechanism 112 can be decoupled from the vehicle 160 and the mobile child-related facility 100 can be deployed stationarily at a location and independently of the vehicle 160. Because the traction devices 108 and the hitching mechanism 112 are generally known devices or systems, they will not be further discussed. Further, the traction devices 108 and the hitching mechanism 112 can respectively include any traction device or any hitching mechanism now known or in the future developed.

The compartment 104 includes various regions with various amenities or child-related facilities usable for caretaking of a child. More particularly, the regions within the compartment 104 correspond to at least one child-friendly relieving area 164 for a child, at least one child-friendly utility space 168 for nursing a child, and at least one vending station 172 including a product vending machine 176 for dispensing one or more products for consumption by a child. A ‘child’, as referred to here, can exemplarily mean, but not be limited to, a young child between zero (“0”) through seven (“7”) years of age. Further, amenities or the child-related facilities offered by the mobile child-related facility 100 can be applicable to or used by other individuals as well, such as, but not limited to, disabled or differently abled individuals. In some embodiments, the compartment 104 also includes at least one spare zone 180. The compartment 104 can include any number of child-friendly relieving areas, child-friendly utility spaces, vending stations, and spare zones, but for ease of reference, they may be simply referred to as a ‘relieving area 164’, a ‘utility space 168’, a ‘vending station 172’, and a ‘spare zone 180’, hereinafter.

The relieving area 164 includes one or more devices or apparatuses. For example, the relieving area 164 includes a changing table 184 for a child, a commode 188, and a toddler seat 192. The relieving area 164 can also include a sink 196 and a dispenser 200.

The changing table 184 can be used to change the clothes of a child or be used to perform other similar activities associated with caretaking a child. The changing table 184 can be mounted to a wall of the relieving area 164 and can be foldable, in some cases, so as to be rested against the wall to make more room within the relieving area 164. In some embodiments, the changing table 184 can be fixedly provided within the relieving area 164 so as to be immovable with respect to the wall. The changing table 184 can also be of a non-fixed type such that it can be freely movable anywhere inside the relieving area 164, or of a type that can be brought out of the relieving area 164. Other devices or apparatuses may be provided at the changing table 184, such as one or more of shelves, toiletry items, and the like, to facilitate a changing activity of a child.

With regard to the commode 188, the commode 188 includes a toilet seat 204 configured to provide a seating platform for a child while the child is relieving himself/herself. The toilet seat 204 can be foldable and/or fixed to the commode 188. In some embodiments, the toilet seat 204 can be removable from the commode 188 such that the toilet seat 204 can be stored away when not in use. In some embodiments, the commode 188 can be used by adults or relatively older individuals, as well.

The toddler seat 192 is separate from the toilet seat 204 and provides a seating platform for a child away from the toilet seat 204. In some embodiments, the toddler seat 192 can seat and support an adult, an elder, or a guardian accompanying the child into the relieving area 164. Further, the dispenser 200 and the sink 196 is usable by a child or by a guardian of the child for any rinsing activity, for example, cleaning the child. In this regard, the dispenser 200 is configured to supply a fluid (for example, water) and the sink 196 is configured to drain out a used volume of the fluid. Effectively, the dispenser 200 and the sink 196 provide one or more occupants of the relieving area 164 a provision by which they can use running fluid, such as water, from the dispenser 200 to clean themselves or others for hygiene purposes.

Further, the relieving area 164 can include one or more of several other devices applicable during a relieving or a caretaking activity of a child, and the list of devices noted above for the relieving area 164 may not be an exhaustive list. For example, the relieving area 164 can also include a temperature control system to maintain the temperature inside the relieving area 164, a self-sanitizing means based on infra-red or any other cleaning or sanitizing means now known or in the future developed to maintain cleanliness and/or hygiene, one or more air-purifiers, one or more mirrors, one or more lighting systems to illuminate the relieving area 164, one or more entertainment systems to allow occupants of the relieving area 164 to listen to any audio stream, audio file, soothing music or watch any video file, watch or play electronic games, participate in interactive activities, and the like, during a caretaking or other child-related activity. Further, the number of such devices or apparatuses, described above for the relieving area 164, can be one or more in number. It will be appreciated that the devices or apparatuses of the relieving area 164 described above can be of any type now known or in the future developed.

As with the relieving area 164, the utility space 168 also includes one or more devices or apparatuses. For example, the utility space 168 includes at least one seating unit 208 and a changing counter 212 for a child. Further, the utility space 168 also includes a basin 216 and a spout 220.

The seating unit 208 can be used to seat and accommodate another individual such as one or more other children or an elder, such as a parent or a guardian, accompanying a child into the compartment 104 or into the utility space 168 of the compartment 104. The seating unit 208 can be used for a child caretaking activity, such as nursing or feeding a child. The seating unit 208 can also be used for other activities, such as for providing a resting place for one or more of a child, a parent, a caretaker, and/or any other accompanying person. Examples of the seating unit 208 can include, but is not limited to, a chair, a sofa, a recliner, a foldable bed, a resting pod, a seat, and/or any resting furniture. In some embodiments, the seating unit 208 can be movable or be immovably attached to a wall or a floor portion of the utility space 168.

As with the changing table 184 of the relieving area 164, the changing counter 212 of the utility space 168 can be used to change the clothes of a child or be used to perform other similar activities associated with caretaking of a child. The changing counter 212 can be mounted to a wall of the utility space 168 and can be foldable, in some cases, so as to be rested against the wall to make more room within the utility space 168. In some embodiments, the changing counter 212 can be fixedly provided within the utility space 168 so as to be immovable with respect to the utility space 168. The changing counter 212 can also be of a non-fixed type such that it can be freely movable anywhere inside the utility space 168, or of a type that can be brought out of the utility space 168. Other devices or apparatuses may be provided at the changing counter 212, such as one or more of shelves, toiletry items, and the like, to facilitate a changing activity of a child.

The spout 220 is configured to supply a fluid (for example, water) for any rinsing activity and the basin 216 is configured to drain out a used volume of the fluid. As with the sink 196 and the dispenser 200, the basin 216 and the spout 220 can effectively provide one or more occupants of the utility space 168 a provision by which they can use running fluid, such as water, from the spout 220 to clean themselves or others up such that they can maintain acceptable levels of hygiene.

The utility space 168 can include one or more of several other devices applicable during a nursing or other caretaking activity of a child, and the list of devices noted above for the utility space 168 may not be an exhaustive list. For example, the utility space 168 can accommodate a temperature control system to maintain the temperature inside the utility space 168, a self-sanitizing means based on infra-red or any other cleaning or sanitizing means to maintain cleanliness and/or hygiene, one or more air-purifiers, one or more lighting systems to illuminate the utility space 168, one or more heating units 224, such as a microwave oven to heat food or other consumable items, and/or one or more entertainment systems 228 to allow occupants of the utility space 168 to listen to any audio stream, audio file, soothing music, or watch any video file, watch or play electronic games, participate in interactive activities, and the like, during a caretaking or other child-related activity. Further, the number of such devices or apparatuses, described above, can be one or more in number. Devices such as heating units 224 and/or the entertainment systems 228 can be provided in other regions of the compartment 104, as well. It will be appreciated that the devices or apparatuses of the utility space 168 described above can be of any type now known or in the future developed.

The product vending machine 176 at the vending station 172 is configured to dispense or provide products (for example, child-related products) for consumption or use by a child or for consumption during one or more child-related activities. As an example, the products can include child-related products such as, but not limited to, diapers, food items, clothing, milk, formula for infants, tissue rolls or boxes, and/or toys. The products listed herein are provided for illustrative purposes and the product vending machine 176 can include other child-related products now known or in the future developed.

The product vending machine 176 includes one or more cabinets 236 (see FIG. 1) to store such products. In some embodiments, the cabinets 236 can include one or more of a visual indication 240 (for illustrative purposes, one visual indication 240 is marked in FIG. 1) indicating a usage status of the cabinets 236. For example, the visual indication 240 can include, but is not limited to, one or more of symbols, images, texts, color codes, and the like, which can be manually configurable or modifiable such that each visual indication can indicate a corresponding status of the cabinets 236. As an example, one or more symbols, images, texts, or color codes, can indicate an occupied status of the corresponding one or more cabinets 236 and another one or more symbols, images, texts, or color codes, can indicate a vacant status of the corresponding one or more cabinets 236.

In some embodiments, the visual indication 240 can be communicated to a server such that the visual indication 240 and thus the status of one or more of the cabinets 236 can be accessed and monitored remotely on devices, such as a digital hand-held device, for example, a smartphone or a tablet or any other communicatively enabled device. In that manner, a real-time usage status of one or more of the cabinets 236 can be provided on those devices. Further, in some embodiments, the cabinets 236 can include corresponding Internet-Of-Things (IoT) based wireless lock systems 244 (for illustrative purposes, only one IoT based wireless lock system 244 is marked in FIG. 1) that can enable the cabinets 236 to be locked or unlocked remotely by an application installable on a device.

It will be appreciated that the type of the cabinets 236 and the visual indication 240 can respectively include any cabinet type or any indication now known or in the future developed. In some embodiments, the cabinets 236 can be integral or separate to the product vending machine 176 and/or can be positioned elsewhere in the compartment 104. In some embodiments, one or more of the product vending machine 176 and/or one or more of the cabinets 236 include a temperature control unit 232 to maintain a temperature of the product vending machine 176 and/or one or more of the cabinets 236. In so doing, a temperature of the products within the product vending machine 176 or one or more of the cabinets 236 can be controller or maintained. The temperature control unit 232 can be of any type now known or in the future developed. In some embodiments, one or more temperature control units, similar to the temperature control unit 232, can individually control a temperature of one or more of the cabinets 236, such that temperature of such one or more cabinets 236 can set and/or maintained differently or independently of one or more other cabinets 236 or other portions of the compartment 104. In so doing, one or more products stored within such temperature controlled cabinets 236 can be refrigerated and maintained (for example, individually and separately) in their prescribed temperature range so as to attain longer shelf life.

The spare zone 180 is usable for activities other than what can be performed in other regions of the compartment 104. Such activities can include napping or resting, and which can be applicable to both a child and/or one or more other person(s) accompanying a child, such as another child or an elder. In this regard, the spare zone 180 includes devices or apparatuses such as a resting furniture 248 that can include a cot or a bed. Further, the spare zone 180 can be located adjacent to the vending station 172 and can provide access (for example, unhindered access) to the product vending machine 176 such that the product vending machine 176 can be accessed to retrieve any one or more child-related products. Such access also helps replenish one or more cabinets 236 of the product vending machine 176 with one or more child-related products.

The spare zone 180 can include one or more of several other devices or apparatuses applicable during napping or resting, and the list of devices or apparatuses noted above for the spare zone 180 may not be an exhaustive list. For example, the spare zone 180 can include a temperature control system to maintain the temperature inside the spare zone 180, a self-sanitizing means based on infra-red or any other cleaning or sanitizing means to maintain cleanliness and/or hygiene, one or more air-purifiers, one or more lighting systems to illuminate the spare zone 180, one or more heating units, such as a microwave oven to heat food or other consumable items, and/or one or more entertainment systems to allow occupants of the spare zone 180 to listen to any audio stream, audio file, soothing music, and the like, during napping or to watch a video file, watch or play electronic games, or participate in interactive activities when resting. The spare zone 180 can also include other devices or apparatuses, such as shelves 252, and the like. Further, the number of devices or apparatuses, described above for the spare zone 180, can be one or more in number. It will be appreciated that the devices or apparatuses of the spare zone 180 described above can be of any type now known or future developed.

In some embodiments, one or more of the aforesaid devices, such as, the heating units, the entertainment systems, the dispenser, the spout, the temperature control systems, the cleaning or sanitizing means, the air-purifiers, the lighting systems, etc., usable in any of the relieving area 164, the utility space 168, or the spare zone 180, can be Internet-Of-Things (IoT) based devices. In that manner, said devices can be controlled by an application installable on a device, for example, a hand-held device, such as a smartphone or a tablet or any other communicatively enabled device, allowing said devices to be controlled remotely.

The relieving area 164, the utility space 168, the vending station 172, and the spare zone 180, in some embodiments, are independent of each other. As an example, and as shown in FIG. 2, the relieving area 164 can occupy a portion of the compartment 104 that is adjacent to the rearward end 120 of the compartment 104; both the vending station 172 and the spare zone 180 can occupy a portion of the compartment 104 that is adjacent to the forward end 116 of the compartment 104; the utility space 168 can occupy a portion of the compartment 104 that is in between the relieving area 164 and the spare zone 180. The relieving area 164, the utility space 168, the vending station 172, and the spare zone 180, can occupy other portions of the compartment 104. It will be appreciated that the configuration described above is provided solely for illustrative purposes.

In some embodiments, the compartment 104 includes at least one changing station 256 for a child. The changing station 256 can be coupled to an external surface 260 of the compartment 104 defined at the rearward end 120 of the compartment 104. The mobile child-related facility 100 can include one or more sidewalls 264 (for example, a first sidewall 264′ and a second sidewall 264″) that extend from the external surface 260 to at least partially surround the changing station 256. Only one sidewall (for example, first sidewall 264′) is illustrated in FIG. 1 to illustrate an exemplary arrangement of the changing station 256. Further, the mobile child-related facility 100 can include an overhead awning 268 configured to be moved between a retracted state and an extended state with respect to the external surface 260. The overhead awning 268 can be applied to shield the changing station 256 from external elements in its extended state. Other devices or apparatuses may be provided at the changing station 256, such as one or more of shelves, toiletry items, and the like, to facilitate a changing activity of a child. The changing station 256, the first sidewall 264′, the second sidewall 264″, and the overhead awning 268, may be of any type now known or in the future developed.

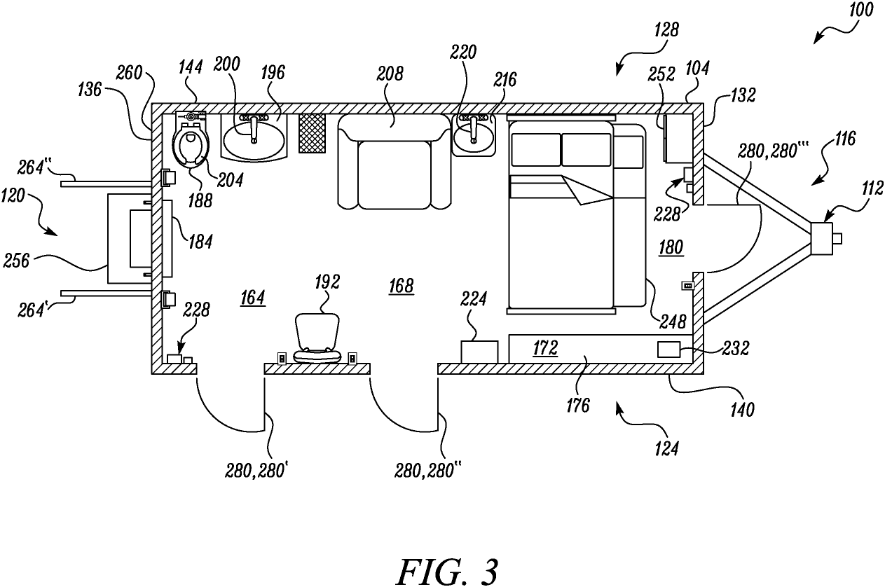

Referring to FIGS. 2 and 3, the compartment 104 can also include one or more walls to separate or partition off one region from the other. For example, the compartment 104 includes a first wall 272 that partitions off the relieving area 164 from the utility space 168 and a second wall 276 that partitions off the utility space 168 from the vending station 172 (see FIG. 2). Given that the spare zone 180 provides access to the product vending machine 176 for replenishing the product vending machine 176 with the various child-related products, a wall between the spare zone 180 and the vending station 172 or the product vending machine 176, in some embodiments, can be omitted or be non-existent. However, when a wall is provided between the spare zone 180 and the vending station 172, access to the vending station 172 or to the product vending machine 176 to replenish the child-related products can be exemplarily provided through a window, an access passageway, or a door defined in such a wall, or alternatively, such an access may be gained from outside the compartment 104.

It will be appreciated that an occupation of various portions of the compartment 104 by the various aforementioned regions (for example, the relieving area 164, the utility space 168, the vending station 172, and the spare zone 180) is exemplary, and thus, the relieving area 164, the utility space 168, the vending station 172, and the spare zone 180, can be interchanged in any suitable way. In this regard, one or more of the first wall 272 or the second wall 276 can be reconfigured in order for any one or more region to take any configuration or position within the compartment 104. Reconfigurable walls allow the compartment 104 to be dynamic and scalable; ready to be modified easily and efficiently as usage patterns dictate. Such a reconfiguration may be facilitated by making the walls (for example, one or more of the first wall 272 or the second wall 276) modular or movable within the compartment 104. More particularly, the walls (for example, one or more of the first wall 272 or the second wall 276) can be movable within the compartment 104 to reconfigure, for example, a position and/or an area of, one or more of the relieving area 164, the utility space 168, and the vending station 172, within the compartment 104. In so doing, room within one or more of the regions can be increased or decreased according to a requirement. In some embodiments, one or more of the first wall 272 or the second wall 276 can be removable or detachable from the compartment 104, and the same may be returned as and when a need arises.

Referring again to FIGS. 1 through 3, the compartment 104 includes one or more access means 280 to provide admission into the compartment 104. Said admission into the compartment 104 provides access to one or more of the relieving area 164, the utility space 168, the vending station 172, and the spare zone 180 of the compartment 104. The access means 280 can be provided on one or more of the forward wall 132, the rearward wall 136, the first lateral sidewall 140, or the second lateral sidewall 144, of the compartment 104.

As an example, the one or more access means 280 corresponds to a first door assembly 280′ configured to provide access to the relieving area 164; a second door assembly 280″ configured to provide access to the utility space 168; and a third door assembly 280‴ configured to provide access to the spare zone 180 and the vending station 172. In some embodiments, the vending station 172 is accessible through the spare zone 180, and, in such cases, an access into the spare zone 180 though the third door assembly 280‴ can mean gaining access to the vending station 172, as well. The mobile child-related facility 100 can also include one or more platforms 284 arranged adjacent to the one or more access means 280 and which can be stepped upon in order to facilitate ingress and egress with respect to one or more regions of the compartment 104.

In some embodiments, one or more of the first door assembly 280′, the second door assembly 280″, and the third door assembly 280‴ respectively include visual indications (for example, only one visual indication 288 is marked corresponding to the first door assembly 280′ for clarity) (see FIG. 1). The visual indications can correspondingly indicate a status of occupancy of the relieving area 164, the utility space 168, and the spare zone 180. Further, one or more of the first door assembly 280′, the second door assembly 280″, and the third door assembly 280‴, can also correspondingly include an Internet-Of-Things (IoT) based wireless door lock system (only one wireless door lock system 292 is marked corresponding to the first door assembly 280′ for clarity) (see FIG. 1) that enables one or more of the first door assembly 280′, the second door assembly 280″, and the third door assembly 280‴, to be locked or unlocked remotely by an application installable on a device, such as a smartphone or a tablet or any other communicatively enabled device now known or later developed.

Although not limited, each of the vending station 172 and one or more or all of the access means 280 are accessible from any one of the first lateral side 124 and the second lateral side 128, as shown in FIG. 2. In so doing, a user need not walk all around the mobile child-related facility 100 to gain access into any of the regions of the compartment 104. Alternatively, one or more of the access means 280 can be provided at other parts of the compartment 104 such that a user can gain access into the compartment 104 from those parts of the compartment 104. In some embodiments, one of the vending station 172 and the access means 280 can be accessible from the first lateral side 124 and the other of the vending station 172 and the access means 280 can be accessible from the second lateral side 128. In some embodiments, access means, similar to the access means 280, can be provided on one or more of the first wall 272 or the second wall 276 such that access to one or more of the relieving area 164, the utility space 168, and the spare zone 180 or the vending station 172 can be provided from within the compartment 104.

Further, in some embodiments, the mobile child-related facility 100 includes one or more access awnings 296. Each of the access awnings 296 can be configured to be moved between a retracted state and an extended state with respect to the compartment 104. The access awnings 296 can be adapted to correspondingly provide shade at one or more of the access means 280 in the extended state. The access awnings 296, as described, can correspond to any awning now known or in the future developed.

With reference to FIG. 3, one or more walls (for example, one or more of the first wall 272 or the second wall 276) between the regions of the compartment 104 can be omitted or be non-existent in some embodiments. In so doing, and the relieving area 164, the utility space 168, and the vending station 172, can be freely accessible to each other from within the compartment 104. In such a case, some of the access means 280 can be omitted as well. For example, when the first wall 272 is omitted, one of the first door assembly 280′ or the second door assembly 280″ can be omitted. For example, when the second wall 276 is omitted, one of the second door assembly 280″ or the third door assembly 280‴ can be omitted. When both the first wall 272 and the second wall 276 are omitted, the number of door assemblies can be reduced to a single door assembly, and which can be suitably provided on any of the forward wall 132, the rearward wall 136, the first lateral sidewall 140, or the second lateral sidewall 144, to gain access into any of the regions of the compartment 104. In some embodiments, when both the first wall 272 and the second wall 276 are omitted, the number of door assemblies can be more that a single door assembly, as well. It will be appreciated that the access means 280 can correspond to any door assembly now known or in the future developed.

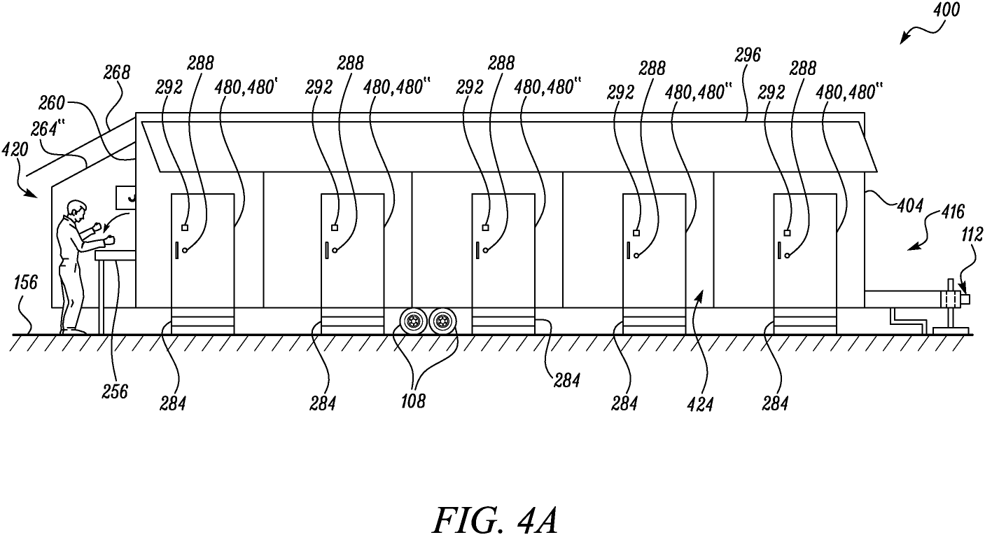

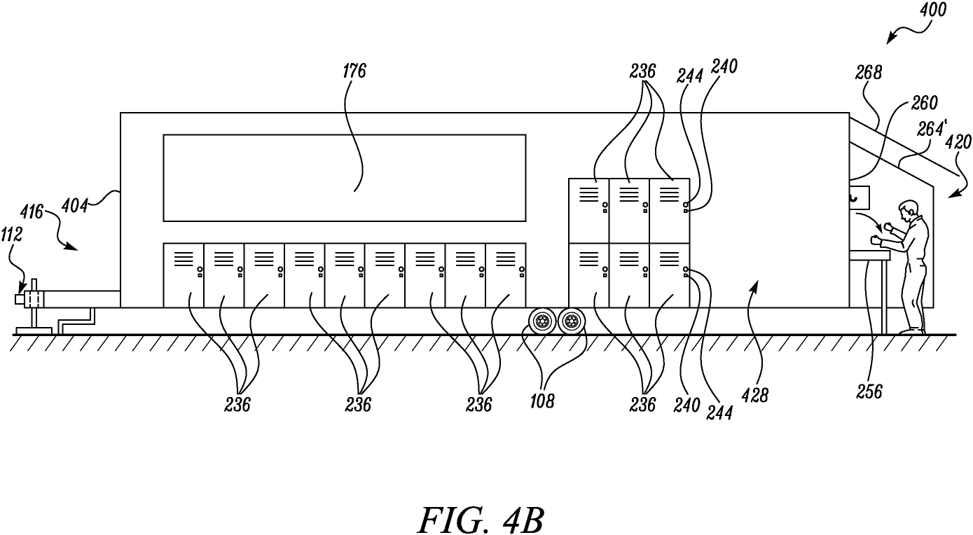

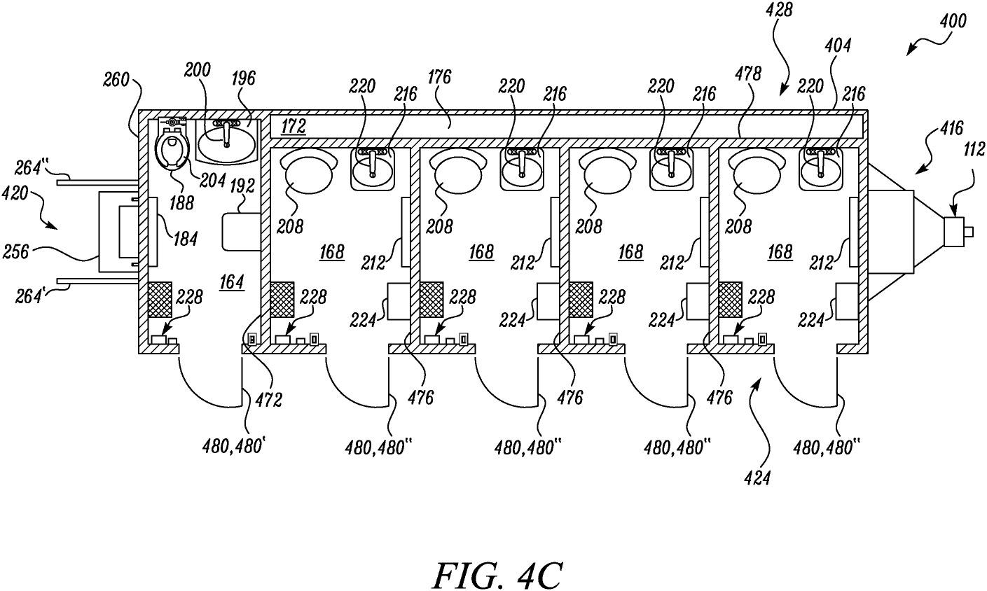

Referring to FIGS. 4A through 4C, an exemplary mobile child-related facility 400 is illustrated and described. The mobile child-related facility 400 includes a compartment 404 similar to the compartment 104 of the mobile child-related facility 100, and, therefore, the same or similar reference numerals are used wherever possible to identify the same or like parts. For example, as with the compartment 104, said compartment 404 can also include a forward end 416, a rearward end 420, a first lateral side 424, and a second lateral side 428. The compartment 404 can also include regions similar to the regions of the compartment 104. It will be noted that the compartment 404 includes an exemplary variation in the manner in which its regions are laid out when compared to the manner in which the regions of the compartment 104 are laid out. For example, the compartment 404 includes a single relieving area 164 and a single vending station 172 like the compartment 104, but includes multiple utility spaces 168, as exemplarily shown in FIG. 4C. Further, a spare zone, such as the spare zone 180, can be omitted in the compartment 404.

Exemplarily, the relieving area 164 of the compartment 404 can be disposed adjacent to the rearward end 420 of the compartment 404, the multiple utility spaces 168 of the compartment 404 can be disposed serially one after the other and can span from the relieving area 164 to the forward end 416, and the vending station 172 of the compartment 404 can be disposed adjacent to the second lateral side 428. Also, it may be noted that walls can be exemplarily provided to separate one region from another region in the compartment 404. For example, a first wall 472 separates the relieving area 164 from the multiple utility spaces 168 and the vending station 172; multiple second walls 476 separates the multiple utility spaces 168 from one another; and a third wall 478 separates the vending station 172 from the multiple utility spaces 168.

Additionally, the compartment 404 can include access means 480, similar to access means 280, and which can include corresponding door assemblies to access each of the relieving area 164 and the multiple utility spaces 168. For example, a first door assembly 480′, similar to the first door assembly 280′, can be provided to access into the relieving area 164; second door assemblies 480″, with each of the second door assemblies 480″ being similar to the second door assembly 280″, can be correspondingly provided to facilitate corresponding access into the multiple utility spaces 168.

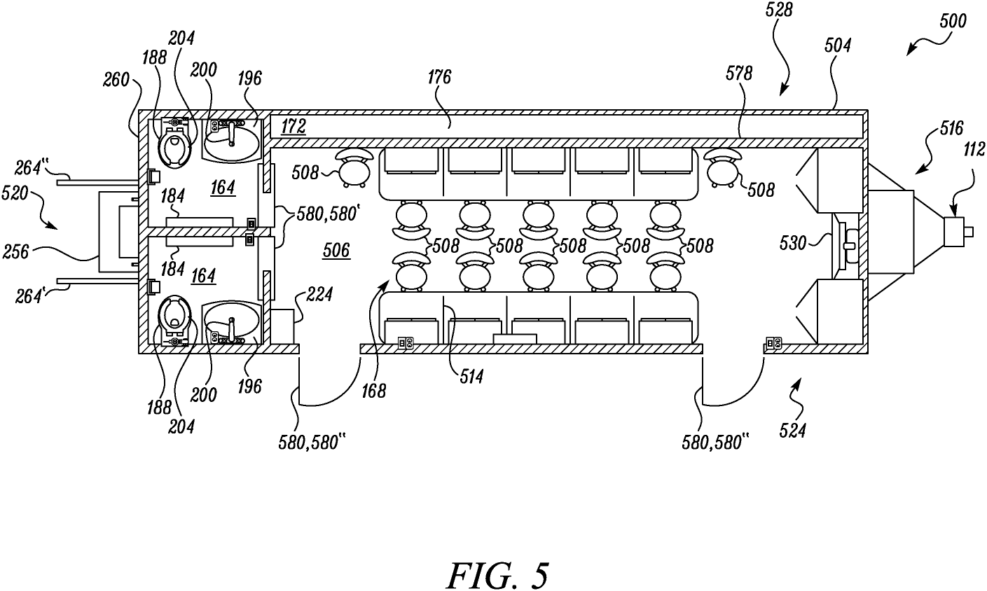

Referring to FIG. 5, another exemplary mobile child-related facility 500 is illustrated and described. The mobile child-related facility 500 includes a compartment 504 similar to the compartment 104 of the mobile child-related facility 100, and, therefore, the same or similar reference numerals are used wherever possible to identify the same or like parts. For example, as with the compartment 104, said compartment 504 can also include a forward end 516, a rearward end 520, a first lateral side 524, and a second lateral side 528. The compartment 504 can also include regions similar to the regions of the compartment 104. However, the compartment 504 includes an exemplary variation in the manner in which its regions are laid out when compared to the manner in which the regions of the compartment 104 are laid out.

For example, the mobile child-related facility 500 includes multiple utility spaces 168 laid out in a main hall 506 of the mobile child-related facility 500. Further, the mobile child-related facility 500 has exemplarily two relieving areas 164 adjacent to the main hall 506, disposed towards the rearward end 520, as shown. The multiple utility spaces 168, as laid out in the main hall 506, span from the two relieving areas 164 towards the forward end 516. Although not limited, access to the relieving areas 164 can be provided from within the main hall 506 through corresponding access means (for example, through first door assemblies 580′). Access to the main hall 506 and/or to the multiple utility spaces 168 from an outside of the compartment 504 can be provided through corresponding access means (for example, through second door assemblies 580″).

The main hall 506 can be devoid of any walls so as to make the multiple utility spaces 168 all accessible to each other, as shown. Although, in some embodiments, walls, such as partial walls 514 (for illustrative purposes, only one partial wall 514 is marked in FIG. 5), can be provided to divide one or more utility spaces 168 from one or more other utility spaces 168 for privacy. Each utility space 168 of the compartment 504 can be similar to the utility space 168 of the compartment 104, and can include a seating unit 508, similar to the seating unit 208. The utility space 168 of the compartment 504 can include one or more other devices or apparatuses similar to the ones discussed for the utility space 168 of the compartment 104. In some embodiments, the main hall 506 can include shelves to store various items. Further, in some embodiments, the main hall 506 can include one or more multimedia or entertainment systems, such as an audio or video system 530 that is commonly used by one or more occupants of the multiple utility spaces 168 of the main hall 506, or alternatively, such systems could be individually included in the utility spaces 168 and used by individual occupants at each utility space 168. Further, the vending station 172 of the compartment 504 can be disposed adjacent to the second lateral side 528. A wall 578 can separate the multiple utility spaces 168 from the vending station 172 of the compartment 504.

The layout of the relieving area 164, multiple utility spaces 168, and the vending station 172, as described for the mobile child-related facilities 100, 400, 500, are exemplary, and the compartments 104, 404, 504 could include various other layouts. In some embodiments, room within the mobile child-related facilities 100, 400, 500 or compartments 104, 404, 504 could be made to accommodate more regions to serve one or more other needs or functions that can arise. Further, a number of relieving areas 164, a number of the multiple utility spaces 168, and/or a number of the vending station 172, are also exemplary. In all such configurations, it will be appreciated that mobile child-related facilities, such as the mobile child-related facilities 100, 400, 500, described above, particularly provide a clean and safe caretaking environment for young children and also provides adults, accompanying a child, with a one stop solution for addressing several caretaking needs a child can require, for example, when participating in outdoor events.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises ...a”, “has ...a”, “includes ...a”, “contains ...a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the description. This method is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A mobile child-related facility, comprising:
a compartment having one or more access means to provide admission into the compartment, the compartment including:
at least one child-friendly relieving area;
at least one child-friendly utility space; and
at least one vending station including a product vending machine for dispensing one or more products for consumption during child-related activities,
wherein the at least one child-friendly relieving area, the at least one child-friendly utility space, and the at least one vending station are independent of each other and are accessible through the one or more access means.

2. The mobile child-related facility of claim 1, wherein the at least one child-friendly relieving area includes:
a changing table;
a commode including a toilet seat configured to provide a seating platform;
a toddler seat separate from the toilet seat; and
a sink and a dispenser, the dispenser configured to supply a fluid and the sink configured to drain out a used volume of the fluid.

3. The mobile child-related facility of claim 1, wherein the at least one child-friendly utility space includes:
at least one seating unit;
a changing counter; and
a basin and a spout, the spout configured to supply a fluid and the basin configured to drain out a used volume of the fluid.

4. The mobile child-related facility of claim 1, wherein the compartment defines a forward end, a rearward end opposite to the forward end, a first lateral side and a second lateral side spanning between the forward end and the rearward end, wherein the one or more access means are provided at one or more of the first lateral side and the second lateral side.

5. The mobile child-related facility of claim 4 further comprising:
at least one changing station coupled to an external surface of the compartment at the rearward end,
one or more sidewalls extending from the external surface to at least partially surround the at least one changing station, and
an overhead awning configured to be moved between a retracted state and an extended state with respect to the external surface, the overhead awning adapted to shield the at least one changing station from external elements in the extended state.

6. The mobile child-related facility of claim 4, wherein each of the at least one vending station and the one or more access means are accessible from one of the first lateral side and the second lateral side.

7. The mobile child-related facility of claim 4, wherein one of the at least one vending station and the one or more access means is accessible from the first lateral side and the other of the at least one vending station and the one or more access means is accessible from the second lateral side.

8. The mobile child-related facility of claim 4 further comprising:
a hitching mechanism arranged at the forward end, the hitching mechanism configured to be coupled to a vehicle; and
a set of traction devices to support the compartment on a surface and facilitate a movement of the mobile child-related facility with respect to the surface.

9. The mobile child-related facility of claim 1, wherein the compartment includes one or more walls to partition off one or more of the at least one child-friendly relieving area, the at least one child-friendly utility space, and the at least one vending station from each other.

10. The mobile child-related facility of claim 9, wherein the one or more walls are movable within the compartment to reconfigure one or more of the at least one child-friendly relieving area, the at least one child-friendly utility space, and the at least one vending station, within the compartment.

11. The mobile child-related facility of claim 1, wherein the compartment includes at least one spare zone including a resting furniture, the at least one spare zone independent of each of the at least one child-friendly relieving area, the at least one child-friendly utility space, and the at least one vending station, and accessible through the one or more access means.

12. The mobile child-related facility of claim 11, wherein the at least one spare zone is located adjacent to the at least one vending station and provides access to the product vending machine for replenishing the product vending machine with the one or more products.

13. The mobile child-related facility of claim 11, wherein the one or more access means corresponds to a first door assembly configured to provide access to the at least one child-friendly relieving area, a second door assembly configured to provide access to the at least one child-friendly utility space, and a third door assembly configured to provide access to the at least one spare zone and the at least one vending station.

14. The mobile child-related facility of claim 13, wherein one or more of the first door assembly, the second door assembly, and the third door assembly respectively include visual indications to indicate a status of occupancy of one or more of the at least one child-friendly relieving area, the at least one child-friendly utility space, and the at least one spare zone.

15. The mobile child-related facility of claim 13, wherein one or more of the first door assembly, the second door assembly, and the third door assembly, include an Internet-Of-Things (IoT) based wireless door lock system that enables one or more of the first door assembly, the second door assembly, and the third door assembly to be locked and unlocked remotely by an application installable on a device.

16. The mobile child-related facility of claim 1 further comprising one or more access awnings, each access awning of the one or more access awnings configured to be moved between a retracted state and an extended state with respect to the compartment, the one or more access awnings adapted to correspondingly provide shade at the one or more access means in the extended state.

17. The mobile child-related facility of claim 1 further comprising one or more Internet-Of-Things (IoT) based devices controllable by an application installable on a device, wherein the one or more IoT based devices correspond to one or more of a lighting system, an entertainment system, and a heating unit.

18. The mobile child-related facility of claim 1 further comprising one or more platforms arranged correspondingly adjacent to the one or more access means to facilitate ingress and egress with respect to the compartment.

19. The mobile child-related facility of claim 1, wherein
the product vending machine includes one or more cabinets for storing the one or more products, wherein the one or more cabinets include a visual indication indicating a usage status of the one or more cabinets, and
the one or more cabinets includes corresponding Internet-Of-Things (IoT) based wireless lock systems that enables the one or more cabinets to be locked or unlocked remotely by an application installable on a device.

20. The mobile child-related facility of claim 19, wherein the one or more of the product vending machine and the one or more cabinets includes one or more temperature control units to maintain a temperature of the one or more of the product vending machine and the one or more cabinets.
